(19) United States
(12) Patent Application Publication
(10) Pub. No.: US 2023/0009709 A1
(43) Pub. Date: Jan. 12, 2023

(54) AIR BLEED VALVE FOR VENTING TRAPPED AIR WITHIN AN INTERNAL COMBUSTION ENGINE COOLING SYSTEM

(71) Applicant: Robby Gordon, Charlotte, NC (US)

(72) Inventor: Robby Gordon, Charlotte, NC (US)

(21) Appl. No.: 17/849,548

(22) Filed: Jun. 24, 2022

Related U.S. Application Data
(60) Provisional application No. 63/219,479, filed on Jul. 8, 2021.

(51) Int. Cl. F01P 11/02; F01P 3/02

(52) U.S. Cl. CPC F01P 11/028; F01P 3/02

(57) ABSTRACT

An apparatus and methods are provided for removing trapped air from a cooling system of an internal combustion engine. The apparatus includes an air bleed valve configured to allow the trapped air to be vented from a water jacket comprising an engine cylinder head. The air bleed valve is coupled with a hollow portion disposed at a top of the cylinder head. A topmost chamber within the hollow portion is in fluid communication with the water jacket. The water jacket includes angled upper walls near the hollow portion configured to direct the trapped air into the topmost chamber. An air bleed line is coupled with the air bleed valve and configured to direct the trapped air out of the topmost chamber to a suitable coolant reservoir.

### PRIORITY

This application claims the benefit of and priority to U.S. Provisional Application, entitled “Air Bleed Valve For Venting Trapped Air Within An Internal Combustion Engine Cooling System,” filed on Jul. 8, 2021, and having application Ser. No. 63/219,479, the entirety of said application being incorporated herein by reference.

### FIELD

Embodiments of the present disclosure generally relate to engine cooling systems. More specifically, embodiments of the disclosure relate to an apparatus and methods for releasing air that may be trapped within an internal combustion engine cooling system.

### BACKGROUND

A water-cooled engine typically comprises a cooling circuit comprising an internal water jacket, a thermostat valve, and a water pump that receives water hoses extending from a radiator. A coolant typically comprising a mixture of water and an anti-freeze, such as ethylene glycol, and flowing within the cooling circuit conducts heat from the engine to the radiator whereby excess heat is removed from the coolant so as to maintain operation of the engine within a suitable temperature range. The thermostat valve typically operates in conjunction with a bottom bypass of the water pump, whereby coolant bypasses the radiator and circulates within an internal water jacket when the temperature of the coolant is low. As the coolant approaches the suitable temperature range, however, the thermostat valve opens and allows the coolant to flow through the radiator by way of the water hoses. Once the coolant reaches the suitable temperature range, the radiator and the thermostat valve cooperate to maintain the operating temperature of the engine.

The water pump typically is powered by the engine, often by way of a belted pulley assembly or by way of a gear set connected between a crankshaft of the engine and the water pump. The water pump generally comprises an impeller or a centrifugal pump that causes the coolant to flow through the engine, hoses, radiator, and other cooling circuit components. A return conduit may be comprised of a water hose whereby coolant heated by operation of the engine is carried to the radiator for cooling.

Over time, the coolant/antifreeze may pick up particles from around the engine, causing corrosion that can lead to leaks and other damage. Removing these particles and restoring corrosion protection of the coolant/antifreeze is crucial to an optimal operation of the cooling system, and helps prevent unexpected breakdowns brought on by overheating, leaks, or engine failure. As such, the coolant must be periodically flushed by draining the coolant from the engine and then adding new coolant/antifreeze to the engine.

A difficulty often encountered when flushing the coolant is removing air trapped inside the engine. For example, air bubbles can become trapped at high points within the cylinder head of the engine. Air within the cooling system is known to give rise to boiling. Once there is any point of boiling, the coolant loses its ability to cool the engine thereby leading to engine failures. Thus, proper cooling of the engine depends on removing all the air trapped within the engine and maintaining a water-only environment within the internal water-jackets of the cylinder head of the engine. As such, embodiments presented herein provide an air bleed valve for releasing air that may be trapped within the water jack of an engine cylinder head.

### SUMMARY

An apparatus and methods are provided for removing trapped air from a cooling system of an internal combustion engine. The apparatus includes an air bleed valve configured to allow the trapped air to be vented from a water jacket comprising an engine cylinder head. The air bleed valve is coupled with a hollow portion disposed at a top of the cylinder head. A topmost chamber within the hollow portion is in fluid communication with the water jacket. The water jacket includes angled upper walls near the hollow portion configured to direct the trapped air into the topmost chamber. An air bleed line is coupled with the air bleed valve and configured to direct the trapped air out of the topmost chamber to a suitable coolant reservoir.

In an exemplary embodiment, an apparatus for removing trapped air from a cooling system of an internal combustion engine comprises: an engine cylinder head including water jackets; a hollow portion that extends upward from the water jackets; a topmost chamber within the hollow portion in fluid communication with the water jackets; and an air bleed valve in fluid communication with the topmost chamber.

In another exemplary embodiment, the air bleed valve is configured to allow the trapped air to escape the water jacket while maintaining a suitable coolant pressure within the cooling system. In another exemplary embodiment, the topmost chamber is configured to receive trapped air within the water jackets. In another exemplary embodiment, the topmost chamber comprises an interior volume disposed above the water jackets. In another exemplary embodiment, angled upper walls comprising the water jacket near the hollow portion are configured to direct the trapped air into the topmost chamber.

In another exemplary embodiment, the air bleed valve is configured to maintain a desired fluid pressure within the cooling system. In another exemplary embodiment, the air bleed valve is configured to allow trapped air within the topmost chamber to exit the cooling system. In another exemplary embodiment, an air bleed line is coupled with the air bleed valve and configured to direct the trapped air to a suitable coolant reservoir. In another exemplary embodiment, the trapped air may be vented from the topmost chamber along with a portion of coolant that enters the air bleed line and pushes the air to the coolant reservoir and out of the air bleed line.

In another exemplary embodiment, the hollow portion comprises a portion of the material comprising the cylinder head. In another exemplary embodiment, the hollow portion comprises a separate component that is threadably engaged with a hole formed in the top of the water jackets.

In an exemplary embodiment, a method for removing trapped air from a cooling system of an internal combustion engine comprises: providing an engine cylinder head including water jackets; extending a hollow portion upward from the water jackets; placing a topmost chamber within the hollow portion in fluid communication with the water jackets; and establishing fluid communication between an air bleed valve and the topmost chamber.

In another exemplary embodiment, establishing fluid communication includes configuring the air bleed valve to allow the trapped air to escape the water jacket while maintaining a suitable coolant pressure within the cooling system. In another exemplary embodiment, placing the topmost chamber includes configuring the topmost chamber to receive trapped air within the water jackets. In another exemplary embodiment, placing the topmost chamber includes disposing the topmost chamber as an interior volume above the water jackets. In another exemplary embodiment, extending the hollow portion includes angling upper walls comprising the water jacket near the hollow portion to direct the trapped air into the topmost chamber.

In another exemplary embodiment, establishing fluid communication includes configuring the air bleed valve to maintain a desired fluid pressure within the cooling system. In another exemplary embodiment, establishing fluid communication includes configuring the air bleed valve to allow trapped air within the topmost chamber to exit the cooling system. In another exemplary embodiment, establishing fluid communication includes coupling an air bleed line with the air bleed valve to direct the trapped air to a suitable coolant reservoir. In another exemplary embodiment, establishing fluid communication includes venting the trapped air from the topmost chamber along with a portion of coolant that enters the air bleed line and pushes the air to the coolant reservoir and out of the air bleed line.

These and other features of the concepts provided herein may be better understood with reference to the drawings, description, and appended claims.

### BRIEF DESCRIPTION OF THE DRAWINGS

The drawings refer to embodiments of the present disclosure in which:

FIG. 1 illustrates a perspective view of a vehicle engine that includes an exemplary embodiment of an air bleed line in accordance with the present disclosure;

FIG. 2 illustrates a perspective cross-sectional view along a midline of an exemplary embodiment of an engine cylinder head that includes an air bleed valve, according to the present disclosure;

FIG. 3 illustrates a midline cross-sectional view of an exemplary embodiment of an engine cylinder head that includes an air bleed valve in accordance with the present disclosure; and

FIG. 4 illustrates a lateral cross-sectional view of an exemplary embodiment of an engine cylinder head that includes an air bleed valve in accordance with the present disclosure.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the invention disclosed herein may be practiced without these specific details. In other instances, specific numeric references such as “first valve,” may be made. However, the specific numeric reference should not be interpreted as a literal sequential order but rather interpreted that the “first valve” is different than a “second valve.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

A water-cooled engine typically comprises a cooling circuit comprising an internal water jacket, a thermostat valve, and a water pump which receives water hoses extending from a radiator. A coolant typically comprising a mixture of water and an antifreeze flowing within the cooling circuit conducts heat from the engine to the radiator whereby excess heat is removed from the coolant to maintain operation of the engine within a suitable temperature range. Over time, the coolant/antifreeze may pick up particles from around the engine, causing corrosion that can lead to leaks and other damage. As such, the coolant must be periodically flushed by draining the coolant from the engine and then adding new coolant/antifreeze to the engine. A difficulty often encountered when flushing the coolant is removing air that becomes trapped inside the engine. Proper cooling of the engine depends on removing all the air trapped within the engine and maintaining a water-only environment within the internal water-jacket of the cylinder head of the engine. As such, embodiments presented herein provide an air bleed valve for releasing air that may be trapped within the water jack of an engine cylinder head.

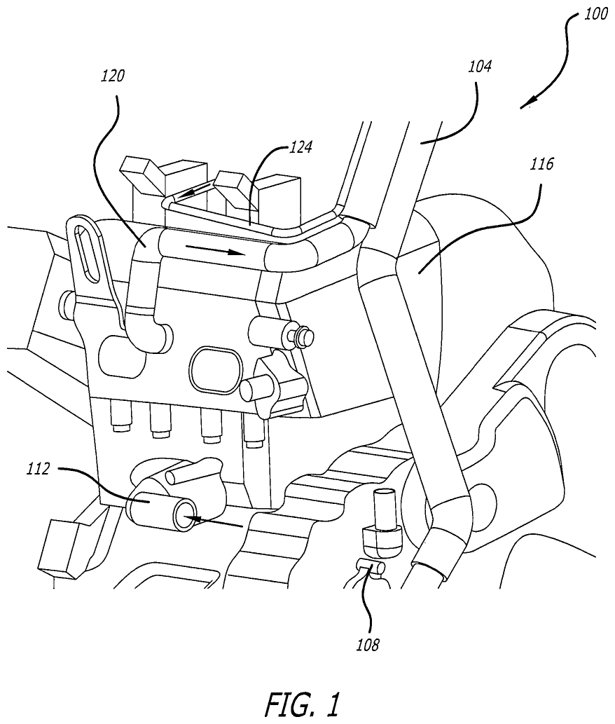

FIG. 1 illustrates a perspective view of a vehicle engine 100 that is particularly suitable for implementing an air bleed valve for releasing air that may become trapped in the upper portions of the water jackets within the cylinder head. As shown in FIG. 1, a coolant supply conduit 104 conducts coolant having a suitable temperature from a radiator to a water pump 108. The water pump 108 pushes the supplied coolant to a water neck 112, by way of a hose (not shown) or other similar conduit, and into water jackets within the engine 100. In general, the water jackets are disposed in locations within the engine 100 that are advantageous for removing excess heat generated during operation of the engine 100. For example, the water jackets may comprise coolant-filled chambers within cylinder walls surrounding combustion chambers of the engine 100. Thus, heat is conducted away from the combustion chambers of the engine 100 by the coolant flowing through the water jackets around the combustion chambers.

As will be appreciated, passages within the engine 100 communicate the coolant from the water jackets surrounding the combustion chambers to water jackets within a cylinder head 116 of the engine 100. As such, the coolant removes excess heat from regions above the combustion chambers, such as around intake and exhaust ports, as well as intake and exhaust valves and cam shafts rotating within the cylinder head 116 during operation of the engine 100. A coolant return conduit 120 attached to the cylinder head 116 is configured to conduct the heated coolant out of the engine 100 and back to the radiator for cooling.

In the embodiment illustrated in FIG. 1, an air bleed line 124 is coupled with a topmost portion of the cylinder head 116 and routed away from the engine 100. The air bleed line 124 is configured to direct away any air that becomes trapped within the upper regions of the water jackets within the cylinder head 116. Air pockets may form within the water jackets of the cylinder head 116 due to air becoming trapped after flushing the cooling system, bubbles forming due to overheating events, leaking elsewhere in the cooling system, a coolant level in a coolant reservoir dropping too low, and the like. It is contemplated that the air bleed line 124 may be connected to a suitable valve disposed in the cylinder head 116 and routed to a suitable coolant reservoir that keeps air from back-flowing into the cooling system. Further, the valve preferably is configured to allow air to escape the water jacket while maintaining a suitable coolant pressure within the cooling system.

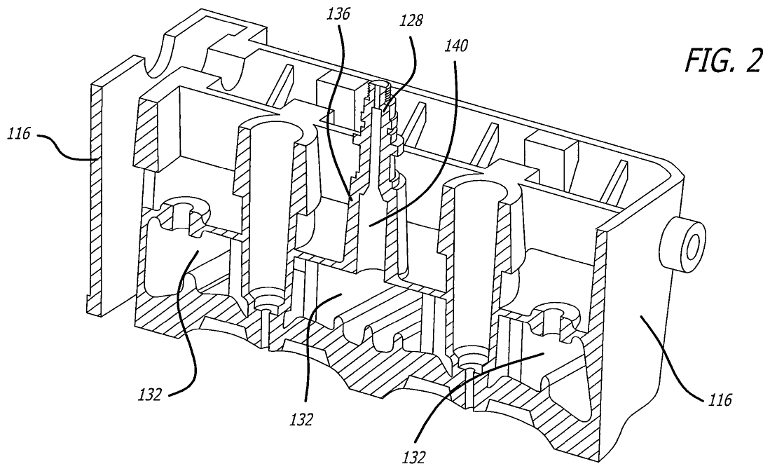

FIG. 2 illustrates a perspective cross-sectional view along a midline of an exemplary embodiment of an engine cylinder head 116 that includes an air bleed valve 128. The air bleed valve 128 is in fluid communication with water jackets 132 that are arranged throughout the cylinder head 116. As described herein, air may become trapped at the upper-most portions of the water jackets 132. The air bleed valve 128 preferably is configured to allow the air to escape the water jacket 132 while maintaining a suitable coolant pressure within the cooling system. As shown in FIG. 2, a hollow portion 136 may be disposed atop the water jackets 132 to provide a topmost chamber 140. It is contemplated that entrapped air will migrate into the topmost chamber 140, due to movement of the engine 100 during operation of the vehicle, and then may be removed from the topmost chamber 140 by way of the air bleed valve 128. As described above, air exiting the cooling system by way of the air bleed valve 128 may be directed to a suitable coolant reservoir by way of the air bleed line 124 shown in FIG. 1.

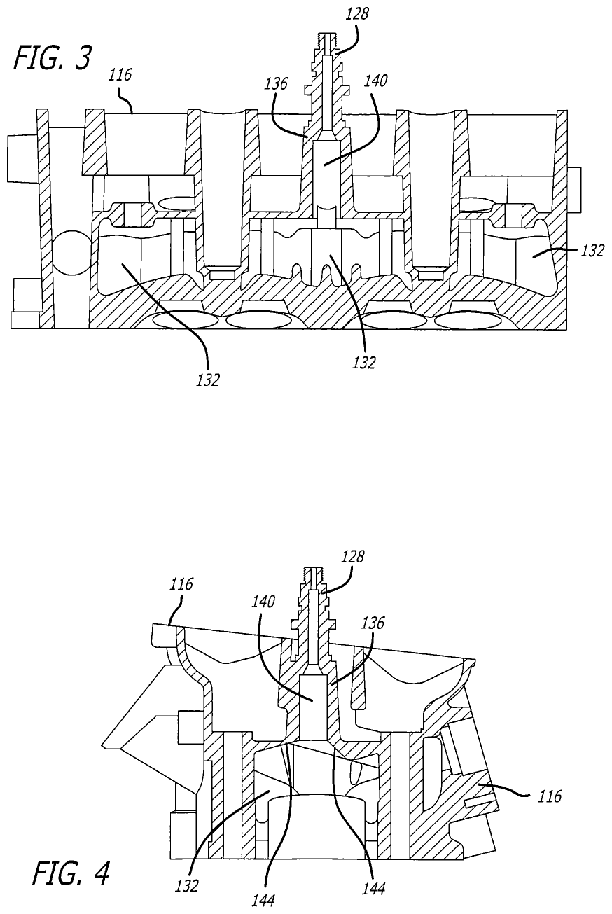

FIG. 3 illustrates a midline cross-sectional view of an exemplary embodiment of an engine cylinder head 116. As shown in FIG. 3, the cylinder head 116 includes an air bleed valve 128 that is situated on top of a hollow portion 136. The hollow portion 136 houses an interior volume that serves as a topmost chamber 140 above water jackets 132 disposed throughout the cylinder head 116. As such, any air trapped in the water jackets will move into the topmost chamber 140 due to movement of the engine 100 during the vehicle traveling over terrain. Air captured by the topmost chamber 140 may be vented, or “bled out” of the water jackets 132, by way of the air bleed valve 128. In some embodiments, air exiting the cooling system by way of the air bleed valve 128 may be directed to a suitable coolant reservoir by way of the air bleed line 124 shown in FIG. 1. In some embodiments, the air bleed valve 128 may be configured to maintain a desired fluid pressure within the cooling system. In such embodiments, air may be vented from the topmost chamber 140 along with a portion of coolant that enters the air bleed line 124 and pushes the air out of the air bleed line 124 and into the coolant reservoir.

FIG. 4 illustrates a lateral cross-sectional view of an exemplary embodiment of an engine cylinder head 116 that includes an air bleed valve 128 in accordance with the present disclosure. As shown in FIG. 4, the air bleed valve 128 may be placed into fluid communication with a topmost chamber 140 that is surrounded by a hollow portion 136. In the illustrated embodiment of FIGS. 3-4, the hollow portion 136 comprises a portion of the material comprising the cylinder head 116. In some embodiments, however, the hollow portion 136 may comprise a separate component that is threadably engaged with a hole formed in the top of the water jackets 132 comprising the cylinder head 116. Further, although the hollow portion 136 illustrated in FIGS. 2-4 is shown having a circular cross-sectional shape, the hollow post 136 is not limited to a circular cross-sectional shape. Rather, the hollow post 136 may be implemented with any of various suitable shapes, sizes, and cross-sections as are found to be advantageous for capturing air within the water jackets 132 of the cylinder head 116.

As described hereinabove, the topmost chamber 140 within the hollow portion 136 serves to capture air entrapped within the water jackets 132. As shown in FIG. 4, the portion of the water jacket 132 that receives the hollow portion 136 may include angled upper walls 144 configured to direct the air into the topmost chamber 140. It is contemplated that during operation of the engine 100, any air bubbles in the cooling system will migrate to the water jackets 132 in the cylinder head 116 and then be directed into the topmost chamber 140 by the angled upper walls 144. Once in the topmost chamber 140, the air may be bled out of the water jackets 132 by way of the air bleed valve 128, as described herein.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. To the extent there are variations of the invention, which are within the spirit of the disclosure or equivalent to the inventions found in the claims, it is the intent that this patent will cover those variations as well. Therefore, the present disclosure is to be understood as not limited by the specific embodiments described herein, but only by scope of the appended claims.

What is claimed is:

1. An apparatus for removing trapped air from a cooling system of an internal combustion engine, comprising:
an engine cylinder head including water jackets;
a hollow portion that extends upward from the water jackets;
a topmost chamber within the hollow portion in fluid communication with the water jackets; and
an air bleed valve in fluid communication with the topmost chamber.

2. The apparatus of claim 1, wherein the air bleed valve is configured to allow the trapped air to escape the water jacket while maintaining a suitable coolant pressure within the cooling system.

3. The apparatus of claim 1, wherein the topmost chamber is configured to receive trapped air within the water jackets.

4. The apparatus of claim 3, wherein the topmost chamber comprises an interior volume disposed above the water jackets.

5. The apparatus of claim 1, wherein angled upper walls comprising the water jacket near the hollow portion are configured to direct the trapped air into the topmost chamber.

6. The apparatus of claim 1, wherein the air bleed valve is configured to maintain a desired fluid pressure within the cooling system.

7. The apparatus of claim 1, wherein the air bleed valve is configured to allow trapped air within the topmost chamber to exit the cooling system.

8. The apparatus of claim 1, wherein an air bleed line is coupled with the air bleed valve and configured to direct the trapped air to a suitable coolant reservoir.

9. The apparatus of claim 8, wherein the trapped air may be vented from the topmost chamber along with a portion of coolant that enters the air bleed line and pushes the air to the coolant reservoir and out of the air bleed line.

10. The apparatus of claim 1, wherein the hollow portion comprises a portion of the material comprising the cylinder head.

11. The apparatus of claim 1, wherein the hollow portion comprises a separate component that is threadably engaged with a hole formed in the top of the water jackets.

12. A method for removing trapped air from a cooling system of an internal combustion engine, comprising:
providing an engine cylinder head including water jackets;
extending a hollow portion upward from the water jackets;
placing a topmost chamber within the hollow portion in fluid communication with the water jackets; and
establishing fluid communication between an air bleed valve and the topmost chamber.

13. The method of claim 12, wherein establishing fluid communication includes configuring the air bleed valve to allow the trapped air to escape the water jacket while maintaining a suitable coolant pressure within the cooling system.

14. The method of claim 12, wherein placing the topmost chamber includes configuring the topmost chamber to receive trapped air within the water jackets.

15. The method of claim 14, wherein placing the topmost chamber includes disposing the topmost chamber as an interior volume above the water jackets.

16. The method of claim 12, wherein extending the hollow portion includes angling upper walls comprising the water jacket near the hollow portion to direct the trapped air into the topmost chamber.

17. The method of claim 12, wherein establishing fluid communication includes configuring the air bleed valve to maintain a desired fluid pressure within the cooling system.

18. The method of claim 12, wherein establishing fluid communication includes configuring the air bleed valve to allow trapped air within the topmost chamber to exit the cooling system.

19. The method of claim 12, wherein establishing fluid communication includes coupling an air bleed line with the air bleed valve to direct the trapped air to a suitable coolant reservoir.

20. The method of claim 19, wherein establishing fluid communication includes venting the trapped air from the topmost chamber along with a portion of coolant that enters the air bleed line and pushes the air to the coolant reservoir and out of the air bleed line.
